(19) United States
(12) Patent Application Publication
(10) Pub. No.: US 2020/0097993 A1
(43) Pub. Date: Mar. 26, 2020

(54) Method and a Computer Software for On-Going Monetization of Service Usage

(71) Applicant: Perion Network Ltd., Holon (IL)

(72) Inventors: Maayan YOSEF, Yavne (IL); Yehonatan NAKACHE, Holon (IL); Shay MANDEL, Kiryat Ono (IL); Liron Haviv TZARFATI, Givat Shmuel (IL)

(21) Appl. No.: 16/137,706

(22) Filed: Sep. 21, 2018

(51) Int. Cl. G06Q 30/02; H04L 29/08

(52) U.S. Cl. CPC G06Q 30/0231; G06Q 30/0232; H04L 67/22

(57) ABSTRACT

A method and a computer program are described for providing a user of a communication device with credits, e.g. virtual credits, based on an on-going usage of one or more selected services, wherein the method comprising: providing the user with a list that comprises identifications of a plurality of services and possible credits associated with each respective service; enabling the user to select at least one service from among the plurality of the services whose identifications are included in that list; tracking on-going usage of the least one selected service by the user; and providing the user with virtual credits based on the tracked usage of the at least one service.

### TECHNICAL FIELD

The present disclosure relates to the field of communications. More particularly, the present disclosure relates to systems and methods implementing novel ways for improving users' experience while using computer applications.

### BACKGROUND

Apps monetization is a field of technology where an application owner uses certain methods for creating revenues from the applications, through usage, actions, behaviors or payments of users.

An application can generate revenues through presentation of advertisements to users, offering rewards, subscription, selling virtual goods or any other applicable way. Subscriptions require the user to do a one-time action (subscribe) which will lead to revenues to the application owner through subscription payment (usually a monthly or an annual fee). Selling virtual goods involves a one-time action that provides a one-time benefit. Watching advertisements is another option, which requires the user to view ads as long as the user is using the application.

Offer Wall is a method for providing the user with a list of options (offers) that he can choose from, to gain rewards based on his selection. For each offer, there is a pre-defined reward, which is a one-time reward. That is, for each action the user gets a reward, and in order for the user to get this reward again, the user must perform the action again from scratch.

The current known methods that are carried out outside of the application, such as sharing on a social media, provide one-time benefit.

The present invention seeks to provide a method for providing a user with benefits based on continuing usage of a selected software application, while the benefits that are actually gained are proportional to the user activities.

### SUMMARY

The disclosure may be summarized by referring to the appended claims.

It is an object of the present disclosure to provide a system and a method for rewarding a user based on his activities which are carried out not as part of the application usage.

It is another object of the present disclosure to provide a system and a method for measuring the amount of activities which are performed not as part of the application usage.

It is yet another object of the present disclosure to provide a system and a method for calculating the value of the activity or activities performed by a user. The value can be expressed in any type of currency, monetary, virtual or any other applicable type of reward.

It is still another object of the present disclosure to provide a system and a method for enabling an application to provide the user with benefits based on the user's activities, be it a one-time activity which is not part (i.e. outside) of the application, or an activity that continues over time.

Other objects of the present disclosure will become apparent from the following description.

According to a first embodiment of the present disclosure, there is provided a method for providing a user of a communication device with credits (e.g. virtual credits), based on an on-going usage of one or more selected services, wherein the method comprising:

providing the user with a list that comprises identifications of a plurality of services and possible credits associated with each respective service;

enabling the user to select at least one service from among the plurality of the services whose identifications are included in that list;

tracking on-going usage of the at least one selected service by the user; and

providing the user with credits based on the tracked usage of the at least one service.

The term “communication device” as used herein throughout the specification and claims encompasses any applicable user device that has an Internet connection, such as a mobile device (e.g. a smart phone), a desktop computer, a smart TV, any hand-held communication device, etc.

According to another embodiment, the on-going usage of the service by the user is a member of a group that consists of: a) a period of time during which at least one software application configured to enable provisioning of the at least one service was installed at the user's communication device; b) number of times that the user was actively connected to the at least one software application configured to enable provisioning of the at least one service; and c) a combination of a) and b).

The term “actively connected” as used herein throughout the specification and claims should be understood to encompass “interacted” and/or performed an activity. As will be appreciated by those skilled in the art, there could be cases where the user has not connected to the service provided in accordance with the present disclosure, or no application has yet been installed at the user's communication device, yet the user activity may still be tracked. For example, in a case of conducting an Internet search, the user may be using the default browser installed on his device, search directly by using the associated search engine (e.g. bing™), still that search engine (e.g. bing™) may report the number of times the user has conducted the search.

By yet another embodiment, the at least one selected service is a searching engine configured to provide an Internet searching service to the user, and the usage of this searching engine by the user is associated with a period of time during which the searching engine was installed and/or configured at the user communication device before it has been un-installed from that device.

In accordance with still another embodiment, the method further comprising a step of providing a correlation between the period of time during which the user was using the at least one selected service and the virtual credit to which he is entitled. Preferably, the correlation is not a linear correlation, in order to allow that the longer the user keeps using the at least one service, the higher is the virtual credit to which he is entitled per unit of time. For example, if the user is entitled to x credits for using a service capacity that is equal to y (or the service for a period of time of y), for using a continued usage of service capacity (or a period of usage) that is equal to 2y, the user will be rewarded with 3× credits.

In accordance with another embodiment, the credit comprises credit points that can be used in a software application (e.g. a gaming application); for issuing a gift card having a value that is proportional to the virtual credit which the user has already gained; for providing the user with a subscription to an application or to a service; to enable the user to request that the credit be converted into a donation and to select the entity to which that donation will be given; or to enable the user to convert the credit to cash and/or credit using for example paypal™ or directly to his bank account.

According to still another embodiment, the method further comprises a step of retrieving identifications of a plurality of services available and of the possible credit associated with each respective service, and preparing a list that comprises the retrieved information.

By yet another embodiment, the method further comprises a step of forwarding one or more indications of the user's usage of the selected service, in order to evaluate duration of the user's usage of the at least one service and/or the aggregated period of time (or number of times) during which the user was actively using the at least one service.

In accordance with another embodiment, each indication is forwarded after a pre-defined period of time has lapsed from forwarding its preceding indication.

According to still another aspect of the disclosure there is provided a computer program product encoding a computer program stored on a non-transitory computer-readable medium for executing a set of instructions by one or more computer processors for carrying out a method for providing a user of a communication device with a credit, based on an on-going usage of one or more selected services.

### BRIEF DESCRIPTION OF THE DRAWINGS

The accompanying drawings, which are incorporated herein and constitute a part of this specification, illustrate several embodiments of the disclosure and, together with the description, serve to explain the principles of the embodiments disclosed herein.

FIG. 1 illustrates a schematic view of a system construed in accordance with an embodiment of the present disclosure; and

FIG. 2 exemplifies a flow chart of a method for carrying out an embodiment of the invention.

### DESCRIPTION OF EXEMPLARY EMBODIMENTS

Some of the specific details and values in the following detailed description refer to certain examples of the disclosure. However, this description is provided only by way of example and is not intended to limit the scope of the invention in any way. As will be appreciated by those skilled in the art, the claimed method and device may be implemented by using other methods that are known in the art per se. In addition, the described embodiments comprise different steps, not all of which are required in all embodiments of the invention. The scope of the invention can be summarized by referring to the appended claims.

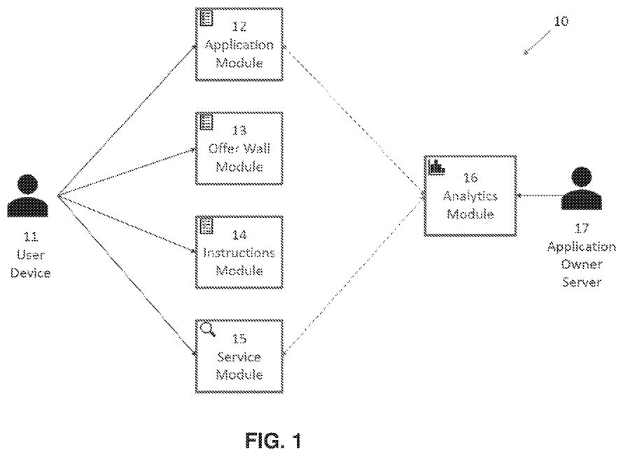

FIG. 1 illustrates a schematic view of an exemplary operating system 10 construed according to a preferred embodiment of the invention. Each of the various sub-system comprised in system 10 includes a computing capability (e.g. a processor). System 10 includes the following. An application module 12, an offer wall module 13, operative to generate and display offers for the user of user device 11, an instructions' module 14, operative to generate and display instructions to user device 11, a service module 15, and an analytics module 16 which is in communication with owner 17 of the application associated with application module 12. It should be noted that the subsystems designated by 12, 13, 14, 15 can be integrally configured or alternatively connected in any suitable manner (e.g. within a single device, or on a device and a plurality of servers, etc.), and which can be hardware enabled or software enabled (or any combination thereof) to carry out functions that are required for system 10 to properly function.

Sub-system 12 (the application module) is a software program that is operative according to the present example on a mobile device. The software application itself is typically provided for upload onto user device 11 by the application owner 17. The application module may utilize a plurality of monetization venues as will be further described.

Offer wall module 13 comprises according to the present example: a software development kit (“SDK”) associated with application module 12; a central repository for storing a plurality of available offers (not shown in this figure); a communication means that enables exchange of information between application module 12 and the repository of offer wall module 13. The exchange of information can be done either through the SDK or directly with the repository through an application programming interface (“API”) that is apparent to the repository; and a computing means (e.g. a processor) configured to process available offers through an API and/or through a user interface.

Instructions module 14 is configured according to this embodiment of the present invention, to forward to user device 11 instructions for the user that relate to steps required to be taken by the user in order to start using a service on a continuing basis, in a way that will enable the system to measure and report his usage of the service.

Service module 15 is configured according to this example to enable provisioning of an on-going service to the user. The term “service” as used herein throughout the specification and claims is used to denote a computer software functionality or a set of computer software functionalities (such as the retrieval of specified information or the execution of a set of operations) with a purpose that different clients can reuse it, together with policies that should control its usage (based on the identity of the client requesting the service, for example). In other words, the term “service” as used herein may be regarded as a mechanism that enables access to one or more capabilities, where the access is provided using a prescribed interface and is exercised consistent with constraints and policies associated with the service. Preferably, a computer software (or a part thereof) that is operative for the provisioning of the service defined hereinabove, is different from a software application that is comprised within the application module that is used in the process of enabling the user to use that service.

Data (e.g. pre-defined indications) retrieved by service module 15 as a result of the usage of the service by the user, is then forwarded to analytics module 16.

Analytics module 16 comprises according to the present invention a processor configured to receive indications forwarded from service module 15; a storage configured to store the received indications, whether they are attributed to a user or to a service or to a combination of a user and a service, depending on the requirements (e.g. constrains) that are as set by the specific service in connection with the provisioning of the virtual credits to a user of that service; a processor configured to query, via an application programming interface or via a user interface, the indications received; and a forwarding means (e.g. a transceiver) configured to convey information to other sub-systems such as application module 12 and/or to the server of the application owner 17, about the received indications.

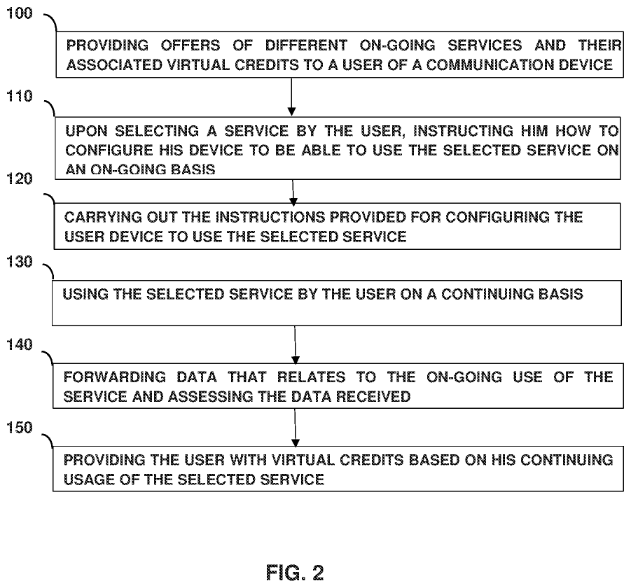

FIG. 2 exemplifies a flow chart of a method construed in accordance with an embodiment of the present invention. According to this example, one or more offers that include an identification of a service that may be provided to the user and the virtual credit that the user will receive upon using that service, are presented to a user (step 100). For example, the relationship between the period of time during which the user was associated with the service and the amount of virtual credit that may be gained in return.

Next, the user selects a service from among the offers presented to him, and he is instructed on how to configure his device in order to enable him to use the selected service, e.g. instructions for changing his search engine to a different one (step 110).

Then, the user carries out the actions specified in the instructions provided (e.g. changes the service provide) (step 120), and thereafter performs on-going activities associated with the selected service (step 130).

Data that relates to on-going user activities made in connection with the selected service is forwarded to an analytics module for assessing the user activities in line with the requirements set for receiving virtual credit based on an on-going usage of the selected service (step 140).

Next, the user is provided with the virtual credits that match his usage of the selected service, according the ore-defined requirements set in order to receive virtual credits based on on-going usage of the selected service (step 150).

While preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing a user of a communication device with credits, based on an on-going usage of one or more selected services, wherein the method comprising:
providing the user with a list that comprises identifications of a plurality of services and possible credits associated with each respective service;
enabling the user to select at least one service from among the plurality of the services whose identifications are included in that list;
tracking on-going usage of the at least one selected service by the user; and
providing the user with virtual credits based on the tracked usage of the at least one service.

2. The method of claim 1, wherein the credit is a virtual credit.

3. The method of claim 1, wherein the on-going usage of the service by the user is a member of a group the consists of: a) a period of time during which at least one software application configured to enable provisioning of the at least one service was installed at the user's communication device; b) number of times that the user was actively connected to the at least one software application configured to enable provisioning of the at least one service; and c) a combination of a) and b).

4. The method of claim 1, wherein the at least one selected service is a searching engine configured to provide an Internet searching service to the user, and the usage of said searching engine by the user is associated with a period of time during which the searching engine was installed and/or configured at the user communication device before it has been un-installed from said user communication device.

5. The method of claim 1, further comprising a step of providing a correlation between a period of time during which the user was using the at least one selected service and credits to which he is entitled, based on said period of time.

6. The method of claim 5, wherein said correlation is not a linear correlation, and ensures that the longer the user keeps using the at least one service, the higher is the virtual credit to which he would be entitled per unit of time.

7. The method of claim 1, further comprising a step of retrieving identifications of a plurality of services available and of the possible virtual credit associated with each respective service, and preparing a list that comprises the retrieved information.

8. The method of claim 1, further comprising a step of forwarding one or more indications of the user's usage of the selected service, in order to evaluate an amount of the user's usage of and/or the user activity at the at least one service.

9. The method of claim 1, further comprising a step of forwarding one or more indications of the user's usage of the selected service, in order to evaluate duration of the user's usage of the at least one service and/or the aggregated period of time during which the user was actively using the at least one service.

10. The method of claim 9, wherein each indication is forwarded after a pre-defined period of time has lapsed from forwarding its preceding indication.

11. A computer program product encoding a computer program stored on a non-transitory computer-readable medium for executing a set of instructions by one or more computer processors for carrying out a method for providing a user of a communication device with credits, based on an on-going usage of one or more selected services, wherein the method comprising:
providing the user with a list that comprises identifications of a plurality of services and possible credits associated with each respective service; enabling the user to select at least service from among the plurality of the services whose identifications are included in that list; tracking on-going usage of the least one selected service by the user; and
providing the user with credits based on the tracked usage of the at least one service.
